(19) United States
(12) Patent Application Publication
(10) Pub. No.: US 2003/0082269 A1
(43) Pub. Date: May 1, 2003

(54) Apparatus for the injection moulding of plastic material

(76) Inventor: Rupert Morwald, Schwertberg (AT)

Correspondence Address: NOTARO & MICHALOS P.C., Suite 2307, 1400 Broadway, New York, NY, 10118-5223, US

(21) Appl. No.: 10/269,678

(22) Filed: Oct. 11, 2002

(30) Foreign Application Priority Data
Oct. 29, 2001 (AT) GM 836/2001

(51) Int. Cl. B29C 45/66

(52) U.S. Cl. 425/589; 425/450.1

(57) ABSTRACT

An apparatus for the injection moulding of plastic material, comprising a stationary and a movable mould mounting plate for the parts of the mould which receives the plastic material, separate devices for displacement of the movable mould mounting plate between an open and a closed position of the mould and for producing the closing force for holding the mould parts together, wherein the movable mould mounting plate bears against at least one fixable abutment which is displaceable in the released condition with the mould mounting plate, wherein a single motor serves for displacement of the movable mould mounting plate, for producing the closing force and for fixing or releasing the abutment.

The invention relates to an apparatus for the injection moulding of plastic material, comprising a stationary and a movable mould mounting plate for the parts of the mould which receives the plastic material, separate devices for displacement of the movable mould mounting plate between an open and a closed position of the mould and for producing the closing force for holding the mould parts together, wherein the movable mould mounting plate bears against at least one fixable abutment which is displaceable in the released condition with the mould mounting plate.

The justification for the use of electrical drives in injection moulding machines, in relation to the closing side of the machine, is substantially reduced to the avoidance of leakages or in general the hydraulic fluid which is deemed to be environmentally harmful. In order for that argument to succeed it is necessary to eliminate all hydraulic drives although a hydraulic piston-cylinder unit affords the required simple linear movements, more easily than an electric motor.

It is not possible to avoid converting the rotary movement of the electric motor into a linear movement. It is however possible to achieve a substantial saving in terms of machine components in an apparatus of the kind defined in the opening part of this specification, if it is provided that a single motor serves for displacement of the movable mould mounting plate, for producing the closing force and for fixing or releasing the abutment.

Advantageously the motor provided drives a spindle which not only converts the rotary movement of the motor into the linear movement of the movable mould mounting plate, but also produces two further linear movements which serve to clamp fast the movable mould mounting plate and to produce the closing force. That is achieved in that the ends of the drive spindle are mounted on the one hand in the movable mould mounting plate and on the other hand in the fixed mould mounting plate in parts which are selectively fixable or displaceable in the direction of the spindle, with respect to the associated mould mounting plate.

Details of the invention are described hereinafter with reference to the drawing in which:

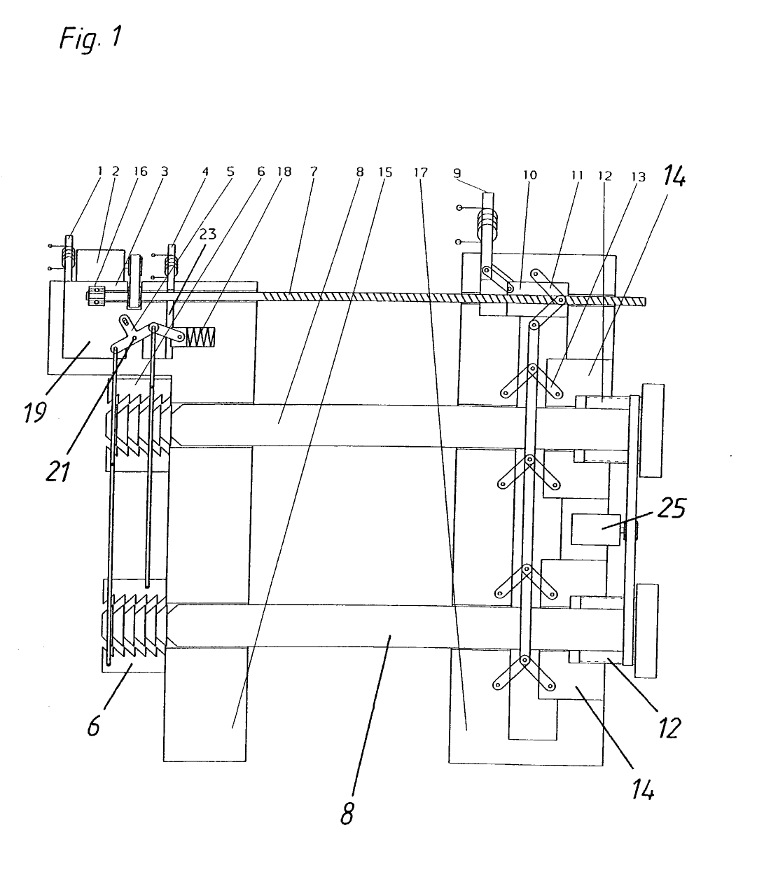

FIG. 1 is a diagrammatic view of the overall concept of the invention,

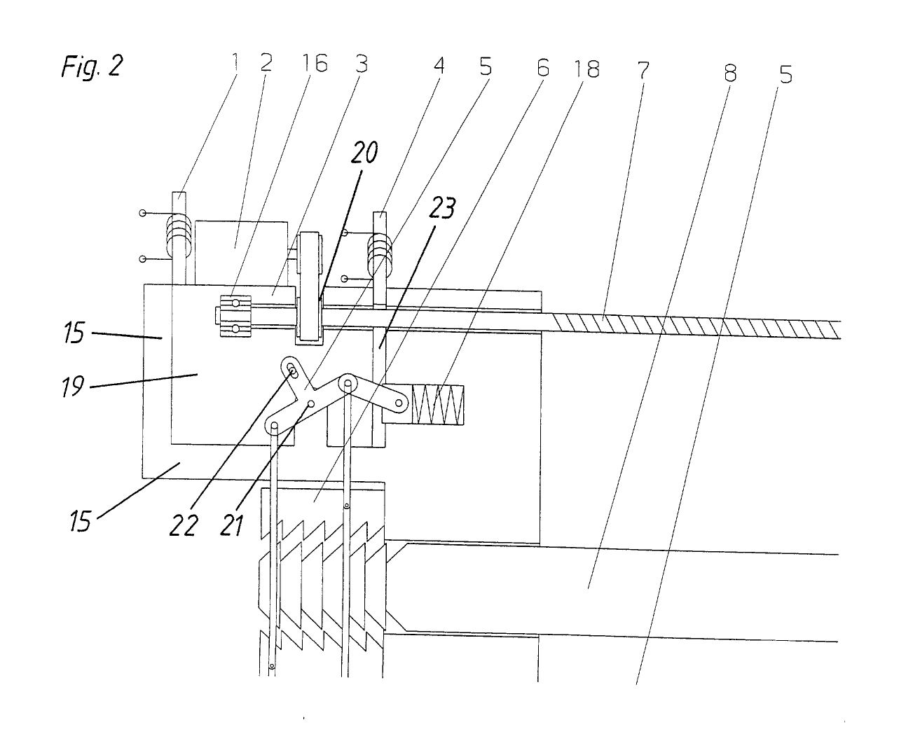

FIG. 2 shows a view on an enlarged scale of the top left side in FIG. 1, and

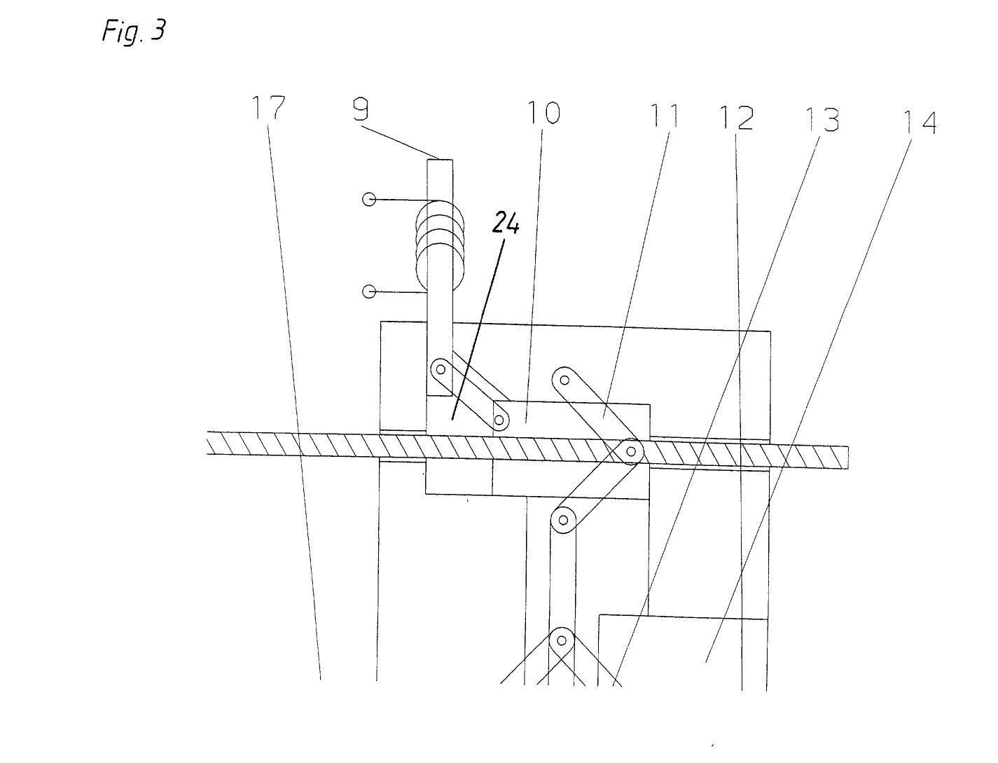

FIG. 3 shows a view on an enlarged scale of the top right side in FIG. 1.

The closing apparatus of an injection moulding machine, which apparatus is shown with the omission of parts which are not essential to the present invention, has a stationary mould mounting plate 17 and a movable mould mounting plate 15. For opening and closing the mould halves (not shown) which are to be fixed to the mould mounting plates, the movable mould mounting plate 15 is moved on the bars 8 in the longitudinal direction of the machine. So that the closed mould does not open under the influence of the injection pressure, abutments 6 are provided in the form of divided clamping nuts, against which the movable mould mounting plate bears while the closing pressure is being applied. At the same time the bars 8 are tensioned by pressure cushions 14 and the closing pressure is generated thereby.

So that the described procedures can be implemented by a single motor 2, the motor is arranged on a slide part 19 which can be selectively locked to the movable mould mounting plate 15 or displaced with respect thereto by the width of the gap 23. An electromechanically actuable lock member 1 serves for fixing the slide part 19 in the front limit position, while a similar lock member 4 serves for fixing it in the rear limit position.

A similar arrangement is provided in the stationary mould mounting plate 17. The mould mounting plate 17 has a recess 32 in which a spindle nut 10 is longitudinally displaceably mounted. Passing through the spindle nut 10 is a spindle 7 whose other end is axially immovably supported in the slide part 19 by means of a bearing 16. The spindle nut 10 is fixed in the recess 32 by the lock member 9.

In the starting position shown in FIG. 1 the movable mould mounting plate 15 is extended, the abutment 6 is opened, the lock member 1 is extended, and the lock members 4 and 9 are inserted. The motor 2 now rotates the spindle 7 at the predetermined speed profile by way of the gear 20 in the closing direction. When the two tool halves are in contact the lock member 4 is drawn out of the gap 23. As a result, in a further sequence, the slide part 19 is moved towards the right. As can be seen in particular from FIG. 2 as a result the lever 5 which is mounted to the movable mould mounting plate 15 is pivoted, which is made possible by virtue of the rotary mounting 21 in the fixed mould mounting plate and the slot 22 on the lever 5, a projection on the slide part 19 passing through the slot 22. In that way the divided nuts on the upper and lower bars 8 close and form abutments 6 against which the movable mould mounting plate bears when the closing pressure builds up. The lock member 1 is then inserted and the lock member 9 withdrawn so that the closing pressure is built up by way of the nut 10 and the lever combination 11 and 13 by a procedure whereby the pressure cushions 14 load the ends of the bars 8. The extent of the movement of the levers 13 depends on the extent to which the nut 12 is screwed in by the motor 25 which serves for mould height adjustment.

When the mould opens, the motor 2 rotates in the opposite direction. Firstly the spindle nut 10 moves towards the right in the recess 32, whereby the closing force is reduced. At the same time the lock member 9 moves into the position shown in FIG. 1. Then the lock member 1 moves out and the slide part 19 moves the lever 5 so that the abutments 6 are opened under the influence of the spring 18. When the slide part 19 has reached its left limit position the lock member 9 moves in and the movable mould mounting plate 15 is moved into the open position shown in FIG. 1.

1. An apparatus for the injection moulding of plastic material, comprising a stationary and a movable mould mounting plate for the parts of the mould which receives the plastic material, separate devices for displacement of the movable mould mounting plate between an open and a closed position of the mould and for producing the closing force for holding the mould parts together, wherein the movable mould mounting plate bears against at least one fixable abutment which is displaceable in the released condition with the mould mounting plate, characterised in that a single motor serves for displacement of the movable mould mounting plate, for producing the closing force and for fixing or releasing the abutment.

2. An apparatus for the injection moulding of plastic material, comprising a stationary and a movable mould mounting plate for the parts of the mould which receives the plastic material, separate devices for displacement of the movable mould mounting plate between an open and a closed position of the mould and for producing the closing force for holding the mould parts together, wherein the movable mould mounting plate bears against at least one fixable abutment which is displaceable in the released condition with the mould mounting plate, characterised in that a single motor serves for displacement of the movable mould mounting plate, for producing the closing force and for fixing or releasing the abutment, wherein a slide part is mounted on the movable mould mounting plate displaceably between two limit positions in the longitudinal direction of the machine, wherein the abutment is fixed on or released from a bar by said displacement.

3. An apparatus according to claim 2 characterised in that for fixing the slide part in each of the two limit positions a respective lock member can be inserted between the slide part and the movable mould mounting plate.

4. An apparatus according to claim 2 characterised in that the motor is fixedly connected to the slide part and a spindle which is supported in the slide part serves to drive the movable mould mounting plate.

5. An apparatus according to claim 1 characterised in that a pressure cushion serves to supplement the closing force, which pressure cushion is actuable with respect to the stationary mould mounting plate by a spindle nut as soon as the longitudinal movement thereof with respect to the stationary mould mounting plate is not prevented by a lock member.
